(19) United States
(12) Patent Application Publication
(10) Pub. No.: US 2018/0014230 A1
(43) Pub. Date: Jan. 11, 2018

(54) UPLINK TIMING SYNCHRONIZATION RECOVERY PROCESS

(71) Applicant: Nokia Technologies Oy, Espoo (FI)

(72) Inventors: Lars DALSGAARD, Oulu (FI); Jorma KAIKKONEN, Oulu (FI); Klaus PEDERSEN, Aalborg (DK)

(21) Appl. No.: 15/543,693

(22) PCT Filed: Jan. 21, 2016
(86) PCT No.: PCT/IB2016/050283

§ 371 Date: Jul. 14, 2017

Related U.S. Application Data
(60) Provisional application No. 62/106,510, filed on Jan. 22, 2015.

(51) Int. Cl. H04W 36/00; H04W 56/00; H04W 72/04

(52) U.S. Cl. CPC H04W 36/0072; H04W 72/048; H04W 56/001; H04W 72/042

(57) ABSTRACT

Systems, methods, apparatuses, and computer program products for an uplink timing synchronization recovery process for RACH-less handover are provided. One method includes detecting, by a network node, that at least one uplink transmission has not been successfully received from a user equipment. The method may also include transmitting a physical downlink control channel (PDCCH) order to the user equipment for re-initiating random access procedure (RACH) in order to become uplink synchronized.

### CROSS-REFERENCE TO RELATED APPLICATIONS

This application claims priority from U.S. Application No. 62/106,510, filed on Jan. 22, 2015. The entire contents of this earlier filed application are hereby incorporated by reference in their entirety.

### BACKGROUND

### Field

Embodiments of the invention generally relate to wireless communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), future 5G radio access technology, and/or High Speed Packet Access (HSPA).

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and most of the RNC functionalities are contained in the enhanced Node B (eNodeB or eNB).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while keeping the backward compatibility. One the key features of LTE-A is carrier aggregation, which allows for increasing the data rates through aggregation of two or more LTE carriers.

### SUMMARY

One embodiment is directed to a method that may comprise detecting, for example by a network node, that UL transmission(s) have not been successfully received from a UE (e.g., over some predetermined time period). The method may then comprise transmitting a PDCCH order to the UE for re-initiating RACH procedure in order to become UL synchronized.

Another embodiment is directed to an apparatus that may comprise at least one processor and at least one memory comprising computer program code. The at least one memory and computer program code may be configured, with the at least one processor, to cause the apparatus at least to detect that UL transmission(s) have not been successfully received from a UE (e.g., over some predetermined time period), and to transmit a PDCCH order to the UE for re-initiating RACH procedure in order to become UL synchronized.

Another embodiment is directed to an apparatus that may comprise means for detecting that UL transmission(s) have not been successfully received from a UE (e.g., over some predetermined time period). The apparatus may also comprise means for transmitting a PDCCH order to the UE for re-initiating RACH procedure in order to become UL synchronized.

Another embodiment is directed to a computer program, embodied on a non-transitory computer readable medium. The computer program may be configured to control a processor to perform a process that may comprise detecting that UL transmission(s) have not been successfully received from a UE (e.g., over some predetermined time period). The process may then comprise transmitting a PDCCH order to the UE for re-initiating RACH procedure in order to become UL synchronized.

Another embodiment is directed to a method that may comprise receiving, by a UE, a PDCCH order from a network node. In response to receiving the PDCCH order from the network, the method may further comprise stopping the usage of an existing TA value and stopping any UL transmissions (other than RA burst transmission). In one embodiment, the receiving of the PDCCH order may further comprise receiving the PDCCH order after a RACH-less handover. According to an embodiment, the stopping of the usage of the existing TA value may include setting the TA timer to expired.

Another embodiment is directed to an apparatus that may comprise at least one processor and at least one memory comprising computer program code. The at least one memory and computer program code may be configured, with the at least one processor, to cause the apparatus at least to receive a PDCCH order from a network node. In response to receiving the PDCCH order from the network, the at least one memory and computer program code may be configured, with the at least one processor, to cause the apparatus at least to stop the usage of an existing TA value and stop any UL transmissions (other than RA burst transmission). In one embodiment, the receiving of the PDCCH order may further comprise receiving the PDCCH order after a RACH-less handover. According to an embodiment, the stopping of the usage of the existing TA value may include setting the TA timer to expired.

Another embodiment is directed to an apparatus that may comprise receiving means for receiving a PDCCH order from a network node. In response to the receiving means receiving the PDCCH order from the network, the apparatus may further comprise stopping means for stopping the usage of an existing TA value and stopping any UL transmissions (other than RA burst transmission). In one embodiment, the receiving means may further comprise means for receiving the PDCCH order after a RACH-less handover. According to an embodiment, the stopping means may comprise means for setting the TA timer to expired.

Another embodiment is directed to a computer program, embodied on a non-transitory computer readable medium. The computer program may be configured to control a processor to perform a process that may comprise receiving a PDCCH order from a network node. In response to receiving the PDCCH order from the network, the process may further comprise stopping the usage of an existing TA value and stopping any UL transmissions (other than RA burst transmission). In one embodiment, the receiving of the PDCCH order may further comprise receiving the PDCCH order after a RACH-less handover. According to an embodiment, the stopping of the usage of the existing TA value may comprise setting the TA timer to expired.

Another embodiment is directed to a method that may comprise stopping, by a UE, all UL transmissions other than RACH when the UE does not receive a proper response to one or more UL transmissions. The method may also comprise receiving a PDCCH order from the network for re-initiating RACH procedure in order to become UL synchronized.

Another embodiment is directed to an apparatus that may comprise at least one processor and at least one memory comprising computer program code. The at least one memory and computer program code may be configured, with the at least one processor, to cause the apparatus at least to stop all UL transmissions other than RACH when the apparatus does not receive a proper response to one or more UL transmissions. The at least one memory and computer program code may further be configured, with the at least one processor, to cause the apparatus at least to receive a PDCCH order from the network for re-initiating RACH procedure in order to become UL synchronized.

Another embodiment is directed to an apparatus that may comprise means for stopping all UL transmissions other than RACH when the apparatus does not receive a proper response to one or more UL transmissions. The apparatus may also comprise means for receiving a PDCCH order from the network for re-initiating RACH procedure in order to become UL synchronized.

Another embodiment is directed to a computer program, embodied on a non-transitory computer readable medium. The computer program may be configured to control a processor to perform a process that may comprise stopping, by a UE, all UL transmissions other than RACH when the UE does not receive a proper response to one or more UL transmissions. The process may also comprise receiving a PDCCH order from the network for re-initiating RACH procedure in order to become UL synchronized.

### BRIEF DESCRIPTION OF THE DRAWINGS

For proper understanding of the invention, reference should be made to the accompanying drawings, wherein:

FIG. 1 illustrates an example of a signaling diagram, according to one embodiment;

FIG. 2a illustrates a block diagram of an apparatus, according to one embodiment;

FIG. 2b illustrates a block diagram of an apparatus, according to another embodiment;

FIG. 3a illustrates a block diagram of an apparatus, according to one embodiment;

FIG. 3b illustrates a block diagram of an apparatus, according to another embodiment;

FIG. 4a illustrates a flow diagram of a method, according to an embodiment; and

FIG. 4b illustrates a flow diagram of a method, according to another embodiment; and

FIG. 4c illustrates a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for an uplink timing synchronization recovery process for RACH-less handover, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Embodiments of the invention generally relate to enhancing mobility for synchronized networks, for example as proposed in 3GPP RAN#65 (RP-141392). This proposed study considers how the handover delay and random access procedure (RACH) overhead could be reduced. One of the motivations for using synchronous RACH-less handover is reduced handover interruption time.

As a part of the concept of enabling RACH-less handover, there are a few options for how the uplink (UL) timing advance (TA) could be derived for the UL transmission without performing the RACH procedure. The main alternatives are that the network could signal this (e.g., based on some a priori information or measurements etc.) or the UE would estimate the TA based on the existing TA and observed timing difference between the cells (serving and target cells).

Using an estimated or pre-calculated TA value instead of an actually measured TA (by the base station to which the UE is connected/communicating) introduces the possibility of wrongly estimating the TA. In other words, there may be some ambiguity between the estimated TA and the true TA which should be used (e.g., TA as it would have been estimated by the eNB based on UE access burst transmission). Thus, there is a need for a fallback mechanism to enable the correcting of the TA for the case where a non-RACH based calculated TA is applied.

3GPP Rel-8 specifies the physical downlink control channel (PDCCH) procedure (PDCCH order), which has been defined to enable the network to trigger the UE to initiate a RACH based access procedure. This was developed and intended for the case when the UE TA timer had expired while the UE was in connected mode (e.g., Timing Advance Timer (TAT) has expired while in connected mode) and the network, for example, has downlink (DL) data for the UE. When the UE receives a PDCCH order from the network, the UE will initiate RACH procedure based on which the network can estimate and update the TA value to be used by the UE. The network may then send the TA value to the UE in the RACH response message after which the UE is UL synchronized.

Current 3GPP specification(s) define how the UE shall behave when the UE receives a PDCCH order. For example, 3GPP TS 36.321 provides that, if a UE receives a PDCCH transmission consistent with a PDCCH order masked with its Cell Radio Network Temporary Identifier (C-RNTI), it shall initiate a RACH procedure. 3GPP TS 36.212 and TS 36.213 also mention other aspects of the RACH procedure as initiated by PDCCH order. However, an approach is needed which can be used by the network to ensure that the UE stops using existing TA value and uplink transmission while the network starts the acquisition process of a new TA.

In the aforementioned scenario where the handover or cell change is performed while skipping the RACH procedure in the target cell (i.e., RACHless procedure), there is a need for an approach to enable the system to recover from wrongly selected or estimated TA value. Embodiments provide a solution which defines the UE behavior so that the UE (e.g., after RACHless HO) may stop its UL transmission and stop using the assigned TA value.

One embodiment for accomplishing this behavior is directed to an eNB triggered procedure. In this embodiment, when the network (e.g., eNB) transmits a PDCCH order to the UE, then, in addition to the existing PDCCH order behavior described above, the UE stops any usage of any existing TA value and stops any UL transmission other than random access (RA) burst transmission.

Another embodiment is directed to a UE based triggered procedure. This alternative embodiment defines a behavior where, if the UE does not receive proper response to one or more UL transmission(s) the UE may cease all UL transmission (other than RACH). For example, a proper response to the UE's UL transmission(s) may include an acknowledgement (i.e., ACK) from the network. If the network does not successfully receive UL transmissions from the UE, the network may send PDCCH order to UE for re-initiating RACH procedure in order to get UL synchronized.

In certain embodiments, the random access procedure may be initiated by a PDCCH order or by the media access control (MAC) sublayer itself. If a UE receives a PDCCH transmission consistent with a PDCCH order masked with its C-RNTI, it may initiate a random access procedure. If the UE has a valid time alignment timer (TAT) for a time alignment group (TAG) for which the PDCCH order is to initate a random access procedure, the UE may set the TAT to expired and perform associated actions. For RA on the primary cell (PCell) a dedicated control channel (DCCH) order or radio resource control (RRC) optionally indicate ra-PreambleIndex and ra-PRACH-MaskIndex. Preamble transmission on PRACH and reception of a PDCCH order may only be supported for PCell.

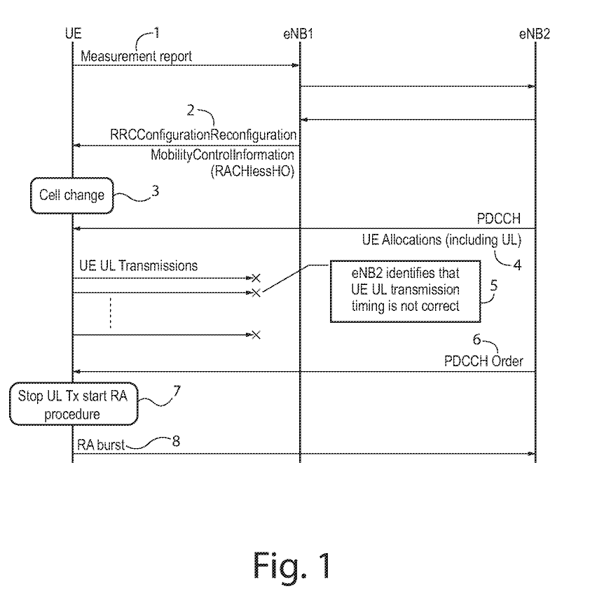

Thus, in certain embodiments, the UE may stop UL transmissions using the available TA and the UE enters the same status concerning UL transmissions as if the UE did not have valid UL TA. UL transmissions will then be initiated in a similar manner as currently when UE receives the PDCCH order from the network, where the UE will initiate RA. FIG. 1 illustrates an example signaling diagram depicting this approach, according to an embodiment of the invention. It should be noted that signaling naming in FIG. 1 is merely illustrative and not all messages shown in FIG. 1 may necessarily be present according to certain embodiments.

The example of FIG. 1 illustrates, at 1, the UE sending a measurement report to eNB1. At 2, eNB1 may send a RRC configuration/reconfiguration message that may include mobility control information (e.g., to trigger RACHless HO). At 3, a cell change for the UE may occur (e.g., the UE may move to a cell served by eNB2). Then, at 4, UE allocations on PDCCH may be sent by eNB2 to the UE. When UE UL transmissions are not received, at 5, eNB2 may identify that UE UL transmission timing is no longer correct. At 6, a PDCCH order may be sent from eNB2 to the UE. At 7, the UE may stop UL transmissions and start RA procedure and, at 8, transmit a RA burst to eNB2. It should be noted that step 4 (i.e., PDCCH with UE allocations after cell change) may not necessarily be performed in some embodiments.

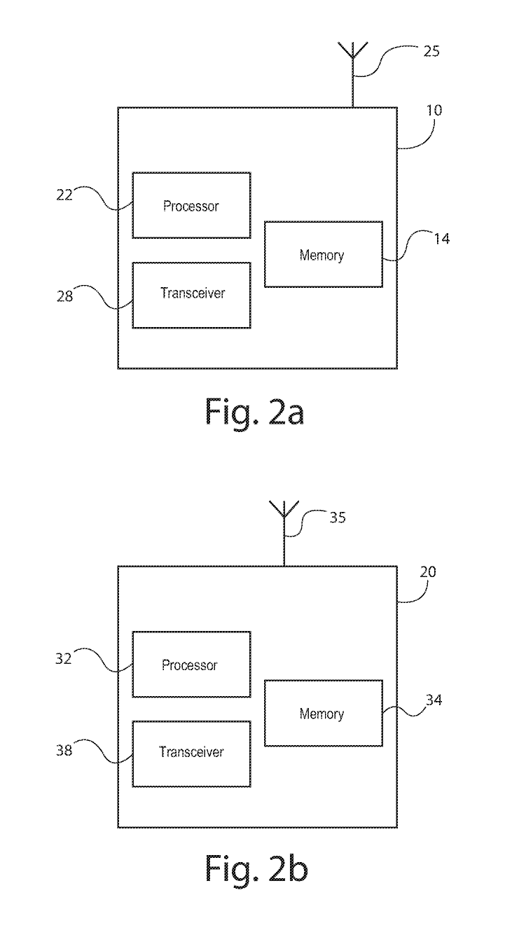

FIG. 2a illustrates an example of an apparatus 10 according to an embodiment. In an embodiment, apparatus 10 may be a node, host, or server in a communications network or serving such a network. For example, apparatus 10 may be a network node or access node for a radio access network, such as a base station, node B or eNB, or an access node of 5G radio access technology. It should be noted that one of ordinary skill in the art would understand that apparatus 10 may include components or features not shown in FIG. 2a.

As illustrated in FIG. 2a, apparatus 10 includes a processor 22 for processing information and executing instructions or operations. Processor 22 may be any type of general or specific purpose processor. While a single processor 22 is shown in FIG. 2a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be a network node or access node, such as a base station, node B, or eNB, or an access node of 5G, for example. According to one embodiment, apparatus 10 may be controlled by memory 14 and processor 22 to transmit a PDCCH order to a UE, which triggers the UE to stop the usage of any existing TA and to stop UL transmissions (other than RA burst transmission). This enables the network to recover from a wrongly selected or estimated TA value, for example, in situations where handover or cell change is performed while skipping the RACH procedure. In another embodiment, when apparatus 10 detects that it has not successfully received UL transmission from a UE (e.g., over some predetermined time period), apparatus 10 may be controlled by memory 14 and processor 22 to transmit a PDCCH order to the UE for re-initiating RACH procedure in order to become UL synchronized. Again, this also enables the network to recover from a wrongly selected or estimated TA value.

FIG. 2b illustrates an example of an apparatus 20 according to another embodiment. In an embodiment, apparatus 20 may be a node or element in a communications network or associated with such a network, such as a UE, mobile device, mobile unit, or other device. For instance, in some embodiments, apparatus 20 may be UE in LTE, LTE-A, or 5G. It should be noted that one of ordinary skill in the art would understand that apparatus 20 may include components or features not shown in FIG. 2b.

As illustrated in FIG. 2b, apparatus 20 includes a processor 32 for processing information and executing instructions or operations. Processor 32 may be any type of general or specific purpose processor. While a single processor 32 is shown in FIG. 2b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a mobile device, such as a UE. In this embodiment, apparatus 20 may be controlled by memory 34 and processor 32 to receive a PDCCH order from a network node, such as a base station, node B, eNB, access point, etc. In an embodiment, the PDCCH order may be received after a RACHless handover. In response to receiving the PDCCH order from the network, apparatus 20 may be controlled by memory 34 and processor 32 to stop the usage of an existing TA value and to stop any UL transmissions (other than RA burst transmission). According to one embodiment, apparatus 20 may be controlled by memory 34 and processor 32 to stop the usage of the existing TA value, for example, by setting the TA timer to expired.

In another embodiment, if apparatus 20 does not receive a proper response from the network to one or more of its UL transmission(s), apparatus 20 may be controlled by memory 34 and processor 32 to stop all UL transmission(s) (other than RACH). Apparatus 20 may then be controlled by memory 34 and processor 32 to receive a PDCCH order that may be sent from the network when it has ceased receiving the UL transmission(s) from the UE. The PDCCH order may cause re-initiating of the RACH procedure in order to get UL synchronized.

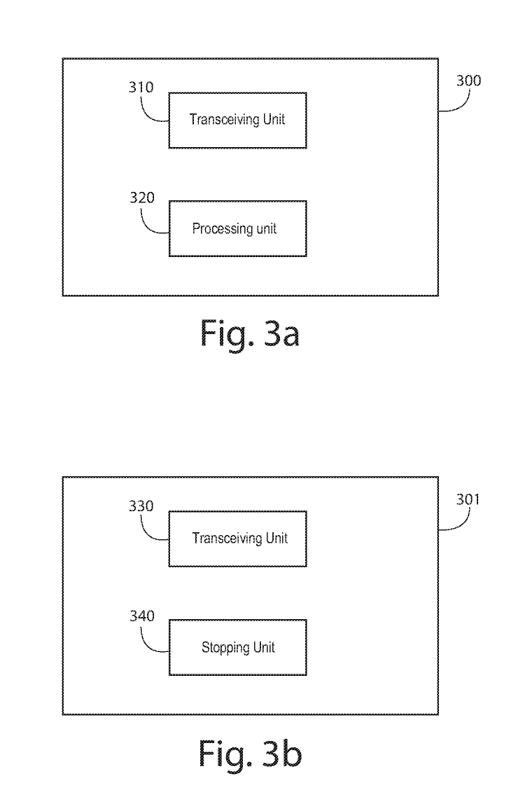

FIG. 3a illustrates a block diagram of an apparatus 300, according to another embodiment of the invention. Apparatus 300 may be a node, host, or server in a communications network or serving such a network. For example, apparatus 300 may be a network node or access node for a radio access network, such as a base station, node B, eNB, or access point. In the example of FIG. 3a, apparatus 300 may include a transceiving unit or means 310 and a processing unit or means 320. According to an embodiment, transceiving unit or means 310 transmits a PDCCH order to a UE, which triggers the UE to stop the usage of any existing TA and to stop UL transmissions (other than RA burst transmission) in order to enable the network to recover from a wrongly selected or estimated TA value, for example, in situations where handover or cell change is performed while skipping the RACH procedure.

In another embodiment, when apparatus 300 detects, for example via processing unit 320, that it has not successfully received UL transmission(s) from a UE (e.g., over some predetermined time period), transceiving unit or means 310 transmits a PDCCH order to the UE for re-initiating RACH procedure in order to become UL synchronized. Again, this also enables the network to recover from a wrongly selected or estimated TA value.

FIG. 3b illustrates a block diagram of an apparatus 301, according to another embodiment of the invention. Apparatus 301 may be a mobile device, such as a UE in LTE, LTE-A, or 5G. In an embodiment, apparatus 301 may include a transceiving unit or means 330 and a stopping unit or means 340. According to one embodiment, transceiving unit or means 330 receives a PDCCH order from a network node, such as a base station, node B, eNB, access point, etc. In response to receiving the PDCCH order from the network, stopping unit or means 340 stops the usage of an existing TA value and stops any UL transmissions (other than RA burst transmission).

In another embodiment, if apparatus 301 does not receive a proper response from the network to one or more of its UL transmission(s), stopping unit or means 340 stops all UL transmission(s) (other than RACH). Transceiving unit or means 330 may then receive a PDCCH order that may be sent from the network, for example, if or when it has ceased receiving the UL transmission(s) from the UE. The PDCCH order may cause re-initiating of the RACH procedure in order to become UL synchronized.

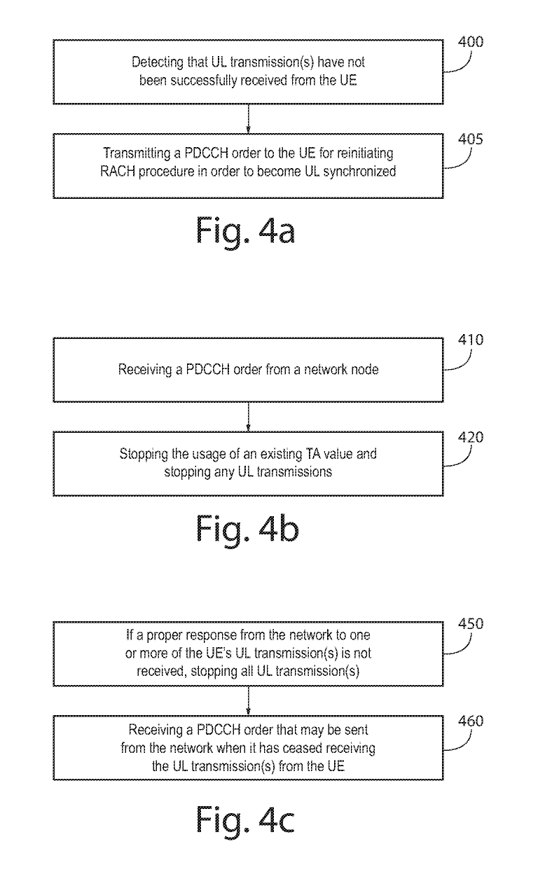

FIG. 4a illustrates an example flow diagram of a method according to one embodiment. In an embodiment, the method of FIG. 4a may be executed by a network node or access node, such as a base station or eNB. As illustrated in FIG. 4a, the method may include, at 405, transmitting a PDCCH order to a UE, which triggers the UE to stop the usage of any existing TA and to stop UL transmissions (other than RA burst transmission) in order to enable the network to recover from a wrongly selected or estimated TA value, for example, in situations where handover or cell change is performed while skipping the RACH procedure. In certain alternative embodiments, the method may include, prior to transmitting the PDCCH order, at 400, detecting that UL transmission(s) have not been successfully received from the UE (e.g., over some predetermined time period), and then, at 405, transmitting a PDCCH order to the UE for re-initiating RACH procedure in order to become UL synchronized.

FIG. 4b illustrates an example flow diagram of a method according to another embodiment. In an embodiment, the method of FIG. 4b may be executed by a mobile device, such as a UE, or by a modem or a chip inside the mobile device. As illustrated in FIG. 4b, the method may include, at 410, receiving a PDCCH order from a network node, such as a base station, node B, eNB, access point, etc. In response to receiving the PDCCH order from the network, the method may further include, at 420, stopping the usage of an existing TA value and stopping any UL transmissions (other than RA burst transmission).

FIG. 4c illustrates an example flow diagram of a method according to another embodiment. In an embodiment, the method of FIG. 4c may be executed by a mobile device, such as a UE, or by a modem or a chip inside the mobile device. As illustrated in FIG. 4c, the method may include, at 450, if a proper response from the network to one or more of the UE's UL transmission(s) is not received, stopping all UL transmission(s) (other than RACH). The method may then include, at 460, receiving a PDCCH order that may be sent from the network when it has ceased receiving the UL transmission(s) from the UE. The PDCCH order may cause re-initiating of the RACH procedure in order to become UL synchronized.

In some embodiments, the functionality of any of the methods described herein, such as those illustrated in FIG. 4a, 4b, or 4c discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

In an embodiment, at least some of the functionalities of any of the apparatuses shown in the Figs. described herein may be shared between two physically separate devices forming one operational entity. Therefore, the apparatuses may be seen to depict the operational entity comprising one or more physically separate devices for executing at least some of the described processes. Such shared architecture, may comprise a remote control unit (RCU), such as a host computer or a server computer, operatively coupled (e.g. via a wireless or wired network) to a remote radio head (RRH) located in the base station or eNB, for example. In an embodiment, at least some of the described processes may be performed by the RCU. In an embodiment, the execution of at least some of the described processes may be shared among the RRH and the RCU. In practice, any digital signal processing task may be performed in either the RRH or the RCU and the boundary where the responsibility is shifted between the RRH and the RCU may be selected according to implementation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-20. (canceled)

21. An apparatus, comprising:
at least one processor; and
at least one memory including computer program code,
wherein the at least one memory and computer program code are configured, with the at least one processor, to cause the apparatus at least to
detect that at least one uplink transmission has not been successfully received from a user equipment; and
transmit a physical downlink control channel (PDCCH) order to the user equipment for re-initiating random access procedure (RACH) in order to have uplink synchronized.

22. The apparatus according to claim 21, wherein the transmitting of the physical downlink control channel (PDCCH) order triggers the user equipment to stop the usage of any existing timing advance and to stop uplink transmissions.

23. The apparatus according to claim 21, wherein the at least one memory and computer program code are further configured, with the at least one processor, to cause the apparatus at least to detect that at least one uplink transmission has not been successfully received from the user equipment over a predetermined time period.

24. The apparatus according to claim 21, wherein the apparatus comprises an evolved node B (eNB).

25. An apparatus, comprising:
at least one processor; and
at least one memory including computer program code,
wherein the at least one memory and computer program code are configured, with the at least one processor, to cause the apparatus at least to
receive a physical downlink control channel (PDCCH) order from a network node; and
stop usage of an existing timing advance value and stopping any uplink transmissions.

26. The apparatus according to claim 25, wherein the at least one memory and computer program code are further configured, with the at least one processor, to cause the apparatus at least to receive the physical downlink control channel (PDCCH) order after a random access procedure (RACH)-less handover.

27. The apparatus according to claims 25, wherein the at least one memory and computer program code are further configured, with the at least one processor, to cause the apparatus at least to set the timing advance timer to expired.

28. The apparatus according to claim 25, wherein the apparatus comprises a user equipment.

29. An apparatus, comprising:
at least one processor; and
at least one memory including computer program code,
wherein the at least one memory and computer program code are configured, with the at least one processor, to cause the apparatus at least to
stop all uplink transmissions other than random access procedure (RACH) when the apparatus does not receive a proper response to one or more uplink transmissions; and
receive a physical downlink control channel (PDCCH) order from the network for re-initiating random access procedure (RACH) procedure in order to become uplink synchronized.
